(19) United States
(12) Patent Application Publication
(10) Pub. No.: US 2014/0178106 A1
(43) Pub. Date: Jun. 26, 2014

(54) DEVELOPING DEVICE AND IMAGE FORMING APPARATUS

(71) Applicant: FUJI XEROX CO., LTD., Tokyo (JP)

(72) Inventors: Takayuki YAMASHITA, Kanagawa (JP); Yasuaki WATANABE, Kanagawa (JP); Jun ABE, Kanagawa (JP); Tomoyuki YOSHII, Kanagawa (JP); Takashi OCHI, Kanagawa (JP); Toji TOKUTSU, Kanagawa (JP)

(73) Assignee: FUJI XEROX CO., LTD., Tokyo (JP)

(21) Appl. No.: 14/014,894

(22) Filed: Aug. 30, 2013

(30) Foreign Application Priority Data
Dec. 21, 2012 (JP) 2012-278859

(51) Int. Cl. G03G 15/09

(52) U.S. Cl. CPC G03G 15/0812
USPC 399/269

(57) ABSTRACT

A developing device includes first and second developing rollers, a trimmer, a divider, and a movement regulator. The first and second developing rollers are arranged so as to face an outer peripheral surface of a photoconductor at downstream and upstream positions, respectively, in a rotation direction of the photoconductor, and respectively include first and second sleeves and first and second magnets. The trimmer is arranged so as to face an outer peripheral surface of the first developing roller, and regulates formation of a layer of developer held by the first developing roller. The divider divides the developer regulated by the trimmer into developer that adheres to the first developing roller and developer that adheres to the second developing roller. The movement regulator is disposed between the trimmer and the divider and regulates movement of the developer held by the first developing roller before the developer is divided.

### Cross-Reference to Related Applications

This application is based on and claims priority under 35 USC 119 from Japanese Patent Application No. 2012-278859 filed Dec. 21, 2012.

### BACKGROUND

(i) Technical Field

The present invention relates to a developing device and an image forming apparatus.

(ii) Related Art

To increase the process speed of image forming apparatuses, such as copying machines and printers, developing devices that develop an image on a photoconductor with plural developing rollers have been developed. The developing devices including plural developing rollers have a higher developing performance and provide a higher printing quality compared to developing devices including a single developing roller.

In the developing devices including plural developing rollers, plural trimmers are required to regulate the amounts of developer supplied to the respective developing rollers.

### SUMMARY

According to an aspect of the invention, there is provided a developing device including a first developing roller arranged so as to face an outer peripheral surface of a photoconductor, which rotates, at a downstream position in a rotation direction of the photoconductor, the first developing roller including a first sleeve and a first magnet, the first sleeve holding developer for developing an image on the photoconductor and rotating in a direction opposite to the rotation direction of the photoconductor, and the first magnet being disposed in the first sleeve and having a magnetic flux density distribution in a circumferential direction of the first sleeve; a second developing roller arranged so as to face the outer peripheral surface of the photoconductor at an upstream position in the rotation direction of the photoconductor, the second developing roller including a second sleeve and a second magnet, the second sleeve holding the developer for developing the image on the photoconductor and rotating in the same direction as the rotation direction of the photoconductor, and the second magnet being disposed in the second sleeve and having a magnetic flux density distribution in a circumferential direction of the second sleeve; a trimmer arranged so as to face an outer peripheral surface of the first developing roller, the trimmer regulating formation of a layer of the developer held by the first developing roller; a divider that divides the developer regulated by the trimmer into developer that adheres to the first developing roller and developer that adheres to the second developing roller; and a movement regulator that is disposed between the trimmer and the divider and that regulates movement of the developer held by the first developing roller before the developer is divided.

### BRIEF DESCRIPTION OF THE DRAWINGS

Exemplary embodiments of the present invention will be described in detail based on the following figures, wherein:

FIG. 1 is a schematic diagram illustrating an image forming apparatus including a developing device according to an exemplary embodiment;

FIG. 2 is a schematic diagram illustrating the developing device according to the exemplary embodiment;

FIGS. 3A and 3B are reference diagrams illustrating formation of a developer layer;

FIGS. 4A and 4B illustrate the manner in which nonuniform layers are formed;

FIG. 5 is a reference diagram illustrating movement of developer;

FIG. 6 illustrates magnetic flux density distributions of developing rollers;

FIGS. 7A to 7C illustrate the arrangements of a movement regulator;

FIG. 8 is a graph showing the grade of a layer for each of the arrangements of the movement regulator; and

FIG. 9 is a schematic diagram illustrating a developing device according to another exemplary embodiment.

### DETAILED DESCRIPTION

### Exemplary Embodiments

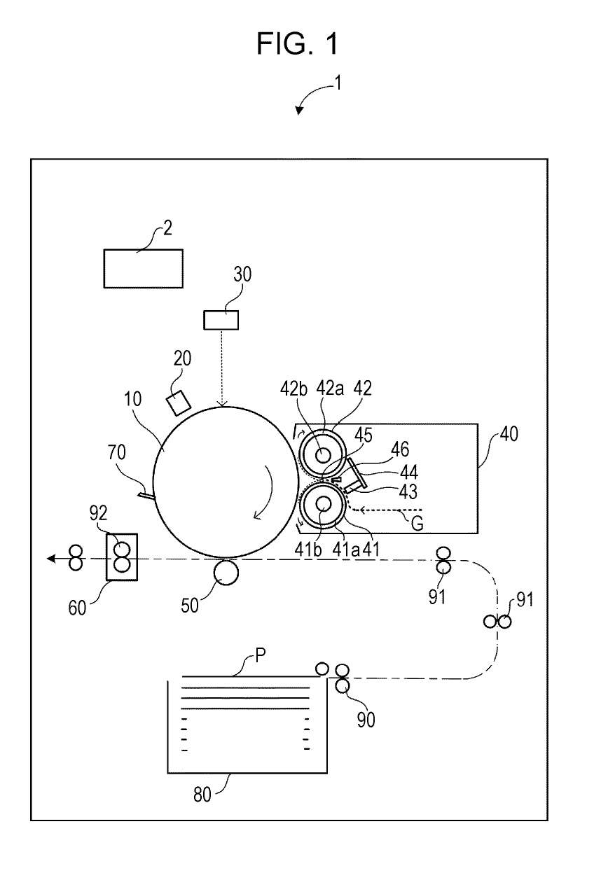

Exemplary embodiments of the present invention will be described with reference to the drawings. FIG. 1 is a schematic diagram illustrating an image forming apparatus including a developing device according to an exemplary embodiment of the present invention. The image forming apparatus 1 according to the exemplary embodiment includes a controller 2, a photoconductor 10, a charging unit 20, an exposure unit 30, a developing device 40, a transfer unit 50, a fixing unit 60, a cleaning unit 70, and a sheet container 80, and forms an image on a sheet P, which is a recording medium, on the basis of image information supplied thereto.

The controller 2 includes an operation device, such as a central processing unit (CPU), and a memory, and controls the operations of components of the image forming apparatus 1. The photoconductor 10 is a cylindrical rotating member that rotates in the direction shown by the arrow in FIG. 1, and includes a photosensitive layer made of an organic photosensitive material that carries an image.

The charging unit 20 applies a predetermined charging voltage to the photoconductor 10 by using, for example, a charging roller that rotates while being in contact with the surface of the photoconductor 10. The charging unit 20 may either be of a contact charging type in which the photoconductor 10 is charged by using a brush that contacts the photoconductor 10 or a non-contact charging type in which the photoconductor 10 is charged by using corona discharge.

The exposure unit 30 irradiates the surface of the photoconductor 10 that has been charged by the charging unit 20 with light corresponding to image data, thereby forming an electrostatic latent image with a latent image potential based on a potential difference. The electrostatic latent image is moved to the position where the developing device 40 is disposed by the rotation of the photoconductor 10.

As illustrated in FIG. 1, the developing device 40 includes a first developing roller 41 and a second developing roller 42 disposed at a downstream position and an upstream position, respectively, in the rotation direction of the photoconductor 10. The first developing roller 41 and the second developing roller 42 attract developer G, which contains toner and carrier, and moves the developer G to the photoconductor 10. The toner contained in the developer G transfers to the surface of the photoconductor 10 owing to the potential difference between the electrostatic latent image formed on the photoconductor 10 and itself. Thus, a toner image is formed on the photoconductor 10. The toner image is moved to the transfer unit 50 by the rotation of the photoconductor 10. The developing device 40 will be described in detail below.

The transfer unit 50 transfers the toner image formed on the photoconductor 10 onto a sheet P that has been transported by transport rollers 91. The sheet P onto which the toner image has been transferred is transported to the fixing unit 60 by the transport rollers 91. The fixing unit 60 fixes the toner image, which has not yet been fixed, to the sheet P by applying pressure and heat with a heating roller 92. The sheet P to which the toner image has been fixed by the fixing unit 60 is further transported by the transport rollers 91 to a receiver.

The cleaning unit 70 removes the toner and the like that remain on the surface of the photoconductor 10 after the toner image has been transferred onto the sheet P. Plural sheets P, which are recording media, are contained in the sheet container 80. The sheets P are taken out of the sheet container 80 by feed rollers 90 and are transported to the transfer unit 50 by the transport rollers 91.

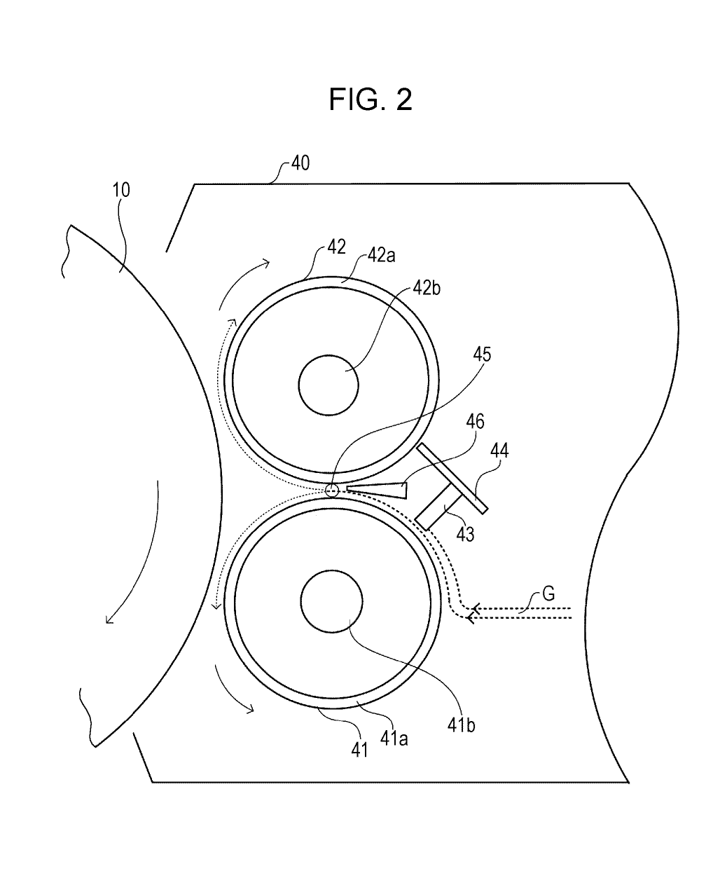

The developing device 40 according to the exemplary embodiment will now be described. FIG. 2 is an enlarged view of the developing device 40 illustrated in FIG. 1. As illustrated in FIG. 2, the developing device 40 includes the first developing roller 41, the second developing roller 42, a trimmer 43, a rectifying plate 44, a divider 45, and a movement regulator 46.

The first developing roller 41 is arranged so as to face the outer peripheral surface of the photoconductor 10, which rotates, at a downstream position in the rotation direction of the photoconductor 10, and includes a first sleeve 41a and a first magnet 41b. The second developing roller 42 is arranged so as to face the outer peripheral surface of the photoconductor 10, which rotates, at an upstream position in the rotation direction of the photoconductor 10, and includes a second sleeve 42a and a second magnet 42b.

The first sleeve 41a and the second sleeve 42a are cylindrical members made of a non-magnetic material, such as aluminum, and hold the developer G used to develop the image on the photoconductor 10. The first sleeve 41a rotates in a direction opposite to the rotation direction of the photoconductor 10, and the second sleeve 42a rotates in the same direction as the rotation direction of the photoconductor 10. In other words, the first sleeve 41a and the second sleeve 42a rotate in the opposite directions.

The first magnet 41b is disposed in the first sleeve 41a, and the second magnet 42b is disposed in the second sleeve 42a. Each of the first magnet 41b and the second magnet 42b is formed by, for example, fixing ferrite magnet pieces to a metal shaft, which distributes the magnetic flux density in the circumferential direction thereof, so that N and S poles of the ferrite magnet pieces are alternately arranged.

The trimmer 43 is arranged so as to face the outer peripheral surface of the first developing roller 41, and regulates the formation of a layer of the developer G on the first developing roller 41. More specifically, the trimmer 43 regulates the height of the layer of the developer G on the first developing roller 41, thereby adjusting the shape of the layer.

The rectifying plate 44 is disposed at an angle with respect to the outer peripheral surface of the second developing roller 42. The rectifying plate 44 removes, that is, scrapes off the developer G that remains on the second developing roller 42, and collects the developer G.

The divider 45 is disposed in a region where the first developing roller 41 and the second developing roller 42 face each other. The divider 45 divides the developer G that has been regulated by the trimmer 43 into developer G that adheres to the first developing roller 41 and developer G that adheres to the second developing roller 42. When, for example, the magnetic flux density of the first magnet 41b and that of the second magnet 42b are substantially equal to each other at the divider 45, the developer G is equally divided into the developer G for the first developing roller 41 and the developer G for the second developing roller 42.

The movement regulator 46 will now be described. As illustrated in FIG. 2, the movement regulator 46 is disposed between the first developing roller 41 and the second developing roller 42, and between the trimmer 43 and the divider 45. The movement regulator 46 is arranged so as to extend to a position immediately in front of the divider 45, that is, to a position on the trimmer-43 side of the divider 45 where a horizontal component and a vertical component of the magnetic flux density of the first developing roller 41 are equal to or substantially equal to each other.

Here, a phenomenon in which a part of the developer G that has been regulated by the trimmer 43 moves from the first developing roller 41 to the second developing roller 42 before the developer G is divided by the divider 45 will be described.

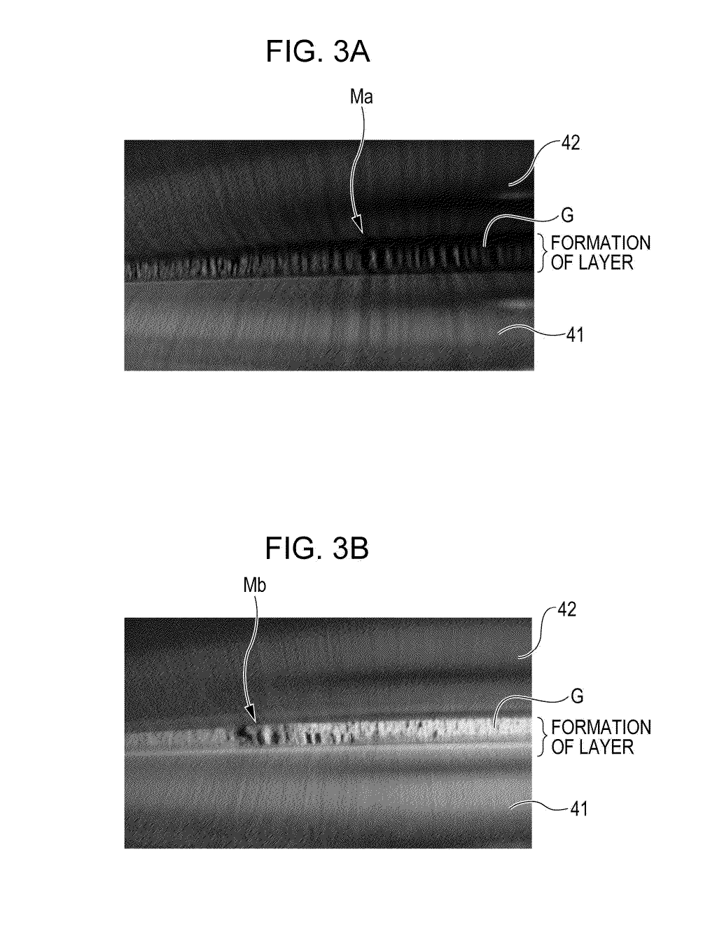

FIGS. 3A and 3B are photographs of the layer of the developer G between the first developing roller 41 and the second developing roller 42 taken from a side at which the photoconductor 10 is disposed. FIG. 3A shows the layer of the developer G between the first developing roller 41 and the second developing roller 42 in a developing device in which the movement regulator 46 is not provided. As shown by the arrow in FIG. 3A, a hole is formed in the layer of the developer G between the first developing roller 41 and the second developing roller 42. Thus, this layer has an irregular portion Ma, such as a hole. The following experiment is performed to determine the cause of formation of the irregular portion Ma.

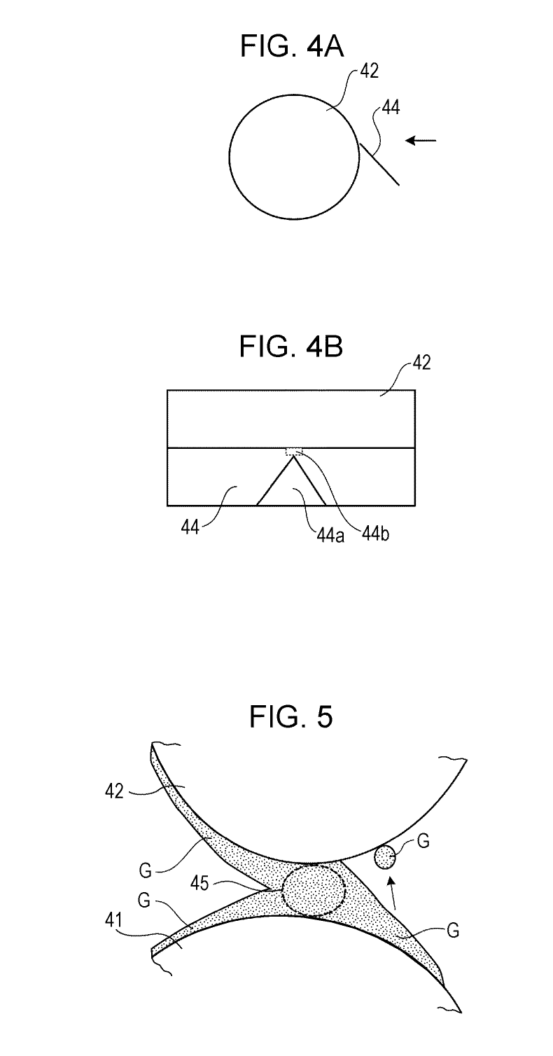

FIGS. 4A and 4B illustrate a structure used in the experiment as an example of a structure in which the irregular portion is formed in the layer. FIG. 4A illustrates the second developing roller 42 and the rectifying plate 44. FIG. 4B illustrates the second developing roller 42 and the rectifying plate 44 viewed in the direction shown by the arrow in FIG. 4A. As illustrated in FIG. 4B, a triangular flow changing member 44a made of plastic that changes the flow of the developer G is attached to the rectifying plate 44. This experiment is performed by using the developing device 40 according to the exemplary embodiment.

As illustrated in FIG. 4B, a vertex portion 44b is provided at the vertex of the triangular flow changing member 44a that points toward the second developing roller 42. This vertex portion 44b is formed so that the developer G that adheres to the second developing roller 42 passes the vertex portion 44b and is not removed by the rectifying plate 44. The developer G that has passed the vertex portion 44b serves as the developer G that could not have been removed, and is moved toward the divider 45 by the rotation of the second developing roller 42.

FIG. 3B shows the layer of the developer G between the first developing roller 41 and the second developing roller 42 in the developing device 40 used in the above-described experiment. As shown by the arrow in FIG. 3B, the layer of the developer G has an irregular portion Mb. The irregular portion Mb and the above-described irregular portion Ma are holes that are similar to each other. Therefore, it may be assumed that these holes are formed because of the developer G that has adhered to a portion of the second developing roller 42 before that portion of the second developing roller 42 reaches the divider 45.

The above-described result shows that the irregularities of the layer of the developer G between the first developing roller 41 and the second developing roller 42 are probably caused by the developer G that moves from the first developing roller 41 to the second developing roller 42 before being divided by the divider 45.

FIG. 5 is a reference diagram showing the simulation of movement of the developer G based on the result of the above-described experiment. As illustrated in FIG. 5, the developer G that has been regulated by the trimmer 43 is divided by the divider 45 into the developer G that adheres to and forms a layer on the first developing roller 41 and the developer G that adheres to and forms a layer on the second developing roller 42.

The simulation shows that a part of the developer G leaves the first developing roller 41 and adheres to the second developing roller 42 owing to, for example, variations in the magnetic flux density before being divided by the divider 45. The developer G that has adhered to the second developing roller 42 is moved to the divider 45 by the rotation of the second developing roller 42, and forms, for example, the above-described irregular portion Ma in the layer between the first developing roller 41 and the second developing roller 42. The movement of the developer G before being divided by the divider 45 has been described.

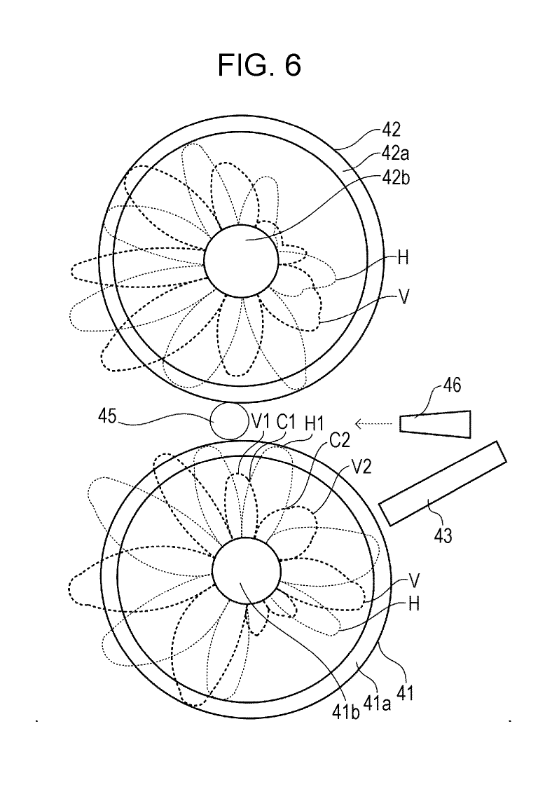

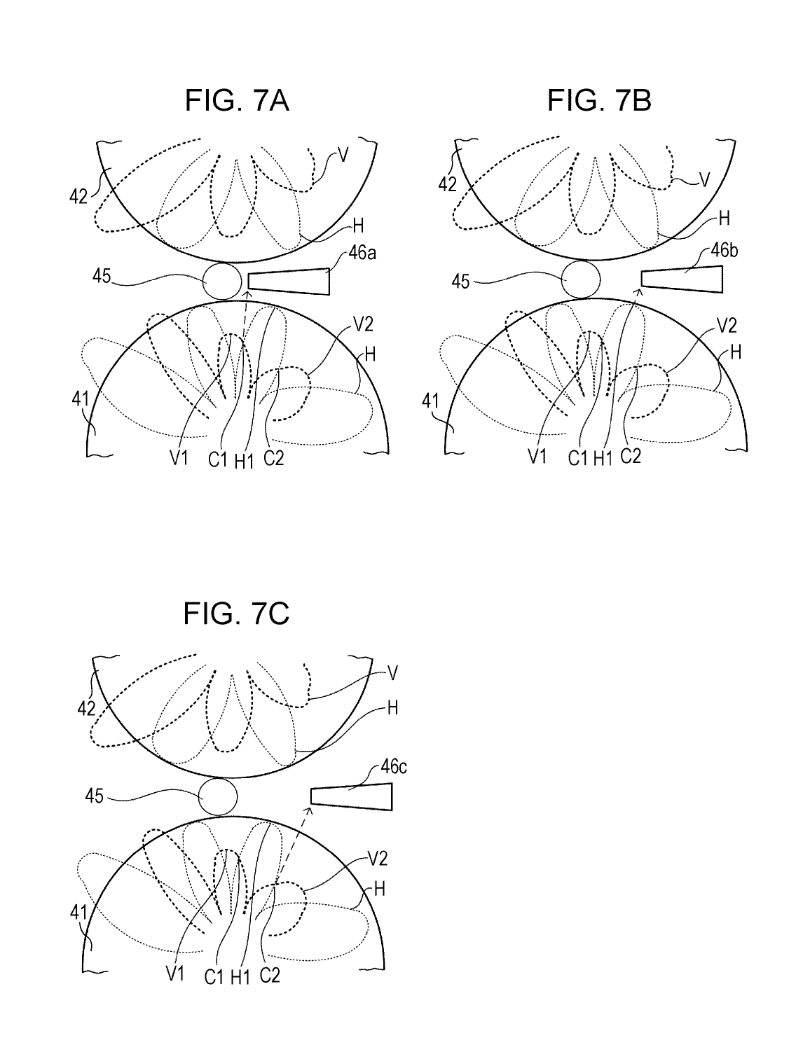

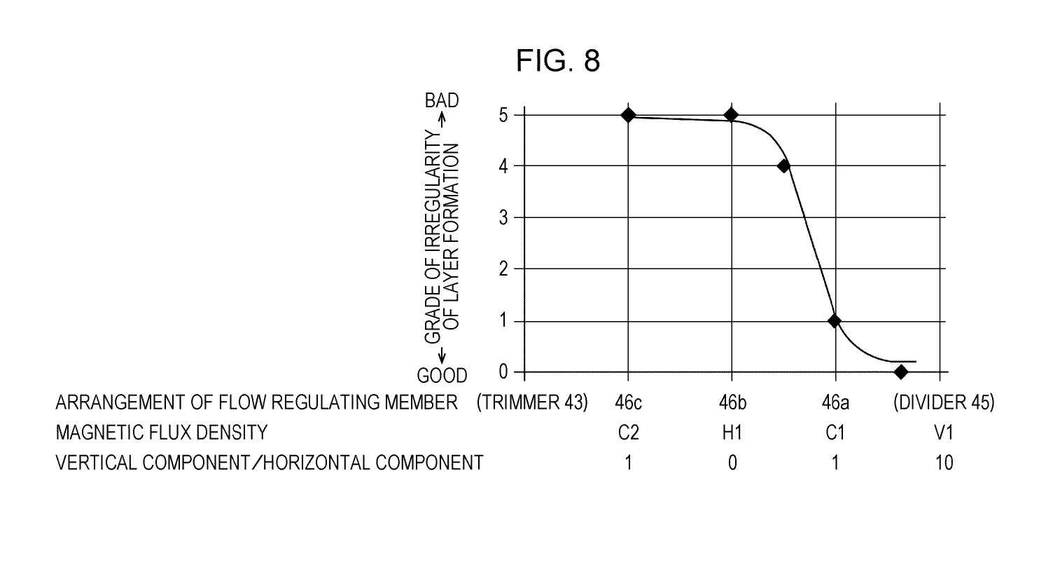

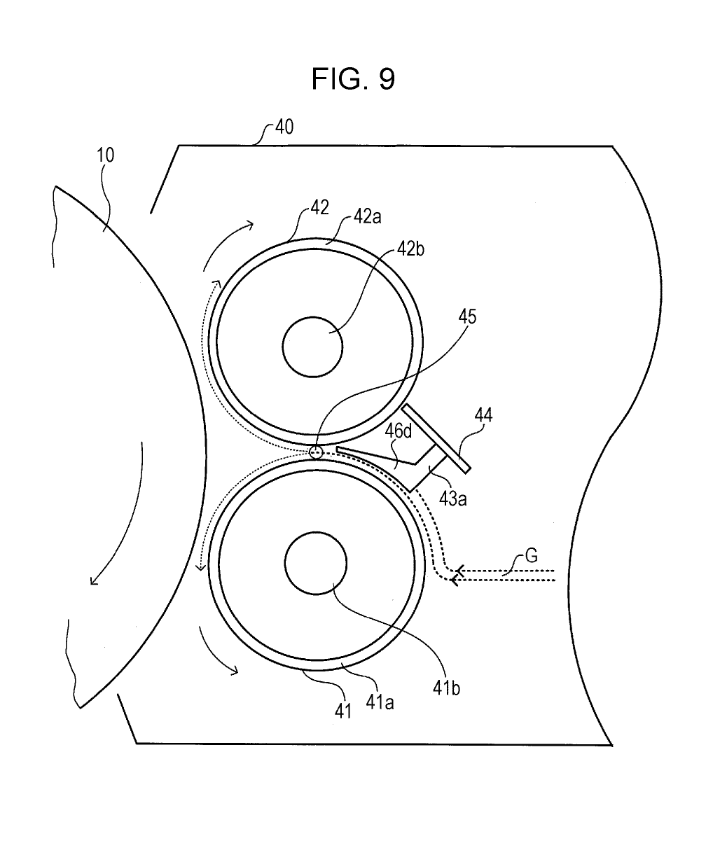

Next, the arrangement of the movement regulator 46 will be described with reference to FIGS. 6 to 8. FIG. 6 illustrates the magnetic flux density distributions of the first developing roller 41 and the second developing roller 42. FIGS. 7A to 7C illustrate the arrangements of the movement regulator 46 with respect to the magnetic flux density distributions illustrated in FIG. 6. FIG. 8 is a graph showing the grade of a layer for each of the arrangements of the movement regulator 46 illustrated in FIG. 7.

First, FIG. 6 will be described. In FIG. 6, the bold broken lines show the vertical magnetic flux density V, which is a vertical component of the magnetic flux density, and the thin broken lines show horizontal magnetic flux density H, which is a horizontal component of the magnetic flux density.

The vertical magnetic flux density V1 illustrated in FIG. 6 is a vertical component of the magnetic flux density in a region around the divider 45. The horizontal magnetic flux density H1 is a horizontal component of the magnetic flux density in a region immediately in front of the divider 45. In other words, the horizontal magnetic flux density H1 is a magnetic flux density at a location between the vertical magnetic flux density V1 and the vertical magnetic flux density V2, which is adjacent to and on the trimmer-43 side of the vertical magnetic flux density V1.

The crossing-position magnetic flux density C1 illustrated in FIG. 6 is the magnetic flux density at the crossing position where the vertical magnetic flux density V1 and the horizontal magnetic flux density H1 cross each other. The crossing-position magnetic flux density C2 is the magnetic flux density at the crossing position where the horizontal magnetic flux density H1 and the vertical magnetic flux density V2 cross each other. Here, the crossing position is the region in which the vertical component and the horizontal component of the magnetic flux density are substantially equal to each other and the ratio of the vertical component of the magnetic flux density to the horizontal component of the magnetic flux density is approximately 1.

The quality evaluation of the layer formed between the first developing roller 41 and the second developing roller 42 will now be described with reference to FIGS. 7A to 7C and 8. The quality evaluation of the layer is performed for each of the cases in which the movement regulator 46 is arranged so as to extend to regions corresponding to the crossing-position magnetic flux density C1, the horizontal magnetic flux density H1, and the crossing-position magnetic flux density C2 illustrated in FIG. 6.

FIGS. 7A to 7C illustrate the arrangements of the movement regulator 46. Referring to FIG. 7A, a movement regulator 46a is arranged so as to extend to a region corresponding to the crossing-position magnetic flux density C1. Referring to FIG. 7B, a movement regulator 46b is arranged so as to extend to a region corresponding to the horizontal magnetic flux density H1 in which the vertical component of the magnetic flux density is zero or approximately zero. Referring to FIG. 7C, a movement regulator 46c is arranged so as to extend to a region corresponding to the crossing-position magnetic flux density C2.

A layer similar to those shown in FIGS. 3A and 3B is formed for each of the arrangements of the movement regulators 46a to 46c, and the quality of each layer is evaluated by visually observing the layer. Specifically, the quality of each layer is evaluated in accordance with the irregularities of the layer by visually observing the layer.

FIG. 8 is a graph showing the result of the visual quality evaluation of each layer. In FIG. 8, the vertical axis represents the quality of each layer of the developer G, that is, the grade of irregularity of each layer. Each layer is graded from 0 to 5 depending on the quality thereof.

The horizontal axis of FIG. 8 shows the position at which the movement regulator 46 is arranged, and also shows the magnetic flux density and the ratio of vertical component to horizontal component of the magnetic flux density at each position. The movement regulator 46a is arranged so as to extend to the position corresponding to the crossing-position magnetic flux density C1, where the ratio of the vertical component to horizontal component of the magnetic flux density is approximately 1. The movement regulator 46b is arranged so as to extend to the position corresponding to the horizontal magnetic flux density H1, where the ratio of the vertical component of horizontal component of the magnetic flux density is approximately 0. The movement regulator 46c is arranged so as to extend to the position corresponding to the crossing-position magnetic flux density C2, where the ratio of the vertical component to horizontal component of the magnetic flux density is approximately 1.

As shown in FIG. 8, the grade of the layer of the developer G is 5 for the arrangements of the movement regulators 46b and 46c. This means that, with the arrangements of the movement regulators 46b and 46c, the movement of the developer G from the first developing roller 41 to the second developing roller 42 occurs.

The grade of the layer of the developer G is 1 for the arrangement of the movement regulator 46a. This means that, with the arrangement of the movement regulator 46a, the movement of the developer G from the first developing roller 41 is suppressed. In consideration of the above-described results, to suppress the movement of the developer G before the developer G is divided, the movement regulator 46 may be arranged so as to extend to the position immediately in front of the divider 45 at which the horizontal component and the vertical component of the magnetic flux density of the first developing roller 41 cross each other.

The developing device 40 according to the exemplary embodiment and the image forming apparatus 1 including the developing device 40 have been described. According to the above-described exemplary embodiment, the movement regulator 46 is provided to prevent the developer G from moving to the second developing roller 42 before being divided by the divider 45. In other words, the developer G is divided into the developer G that adheres to the first developing roller 41 and the developer G that adheres to the second developing roller 42 after the developer chain is formed and the moving force of the developer G becomes sufficiently high. Since the developer G is prevented from freely moving from the first developing roller 41 to the second developing roller 42, a uniform layer may be formed on the photoconductor 10.

### Other Exemplary Embodiments

Although a developing device according to an exemplary embodiment and an image forming apparatus including the developing device have been described above, the present invention is not limited to the above-described exemplary embodiment, and other exemplary embodiments are also possible. Other exemplary embodiments will now be described.

Although the developing device according to the above-described exemplary embodiment includes the movement regulator 46 as a member for regulating the movement of the developer G, the present invention is not limited to this. As another exemplary embodiment, as illustrated in FIG. 9, for example, a movement regulator 46d that is arranged between a divider and a trimmer 43a may be formed integrally with the trimmer 43a.

Although the developing device according to the above-described exemplary embodiment includes two developing rollers, the present invention is not limited to this. As another exemplary embodiment, for example, a developing device may include four or more developing rollers and plural movement regulators.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a first developing roller arranged so as to face an outer peripheral surface of a photoconductor, which rotates, at a downstream position in a rotation direction of the photoconductor, the first developing roller including a first sleeve and a first magnet, the first sleeve holding developer for developing an image on the photoconductor and rotating in a direction opposite to the rotation direction of the photoconductor, and the first magnet being disposed in the first sleeve and having a magnetic flux density distribution in a circumferential direction of the first sleeve;
a second developing roller arranged so as to face the outer peripheral surface of the photoconductor at an upstream position in the rotation direction of the photoconductor, the second developing roller including a second sleeve and a second magnet, the second sleeve holding the developer for developing the image on the photoconductor and rotating in the same direction as the rotation direction of the photoconductor, and the second magnet being disposed in the second sleeve and having a magnetic flux density distribution in a circumferential direction of the second sleeve;
a trimmer that is arranged so as to face an outer peripheral surface of the first developing roller and that regulates formation of a layer of the developer held by the first developing roller;
a divider that divides the developer regulated by the trimmer into developer that adheres to the first developing roller and developer that adheres to the second developing roller; and
a movement regulator that is disposed between the trimmer and the divider and that regulates movement of the developer held by the first developing roller before the developer is divided.

2. The developing device according to claim 1, wherein the movement regulator is arranged so as to extend to a position between the divider and a position immediately in front of the divider where a vertical component of a magnetic flux density of the first developing roller is approximately zero.

3. The developing device according to claim 2, wherein the movement regulator is arranged so as to extend to a position immediately in front of the divider where a horizontal component and the vertical component of the magnetic flux density of the first developing roller are substantially equal to each other.

4. The developing device according to claim 1, wherein the movement regulator is integrated with the trimmer.

5. The developing device according to claim 2, wherein the movement regulator is integrated with the trimmer.

6. The developing device according to claim 3, wherein the movement regulator is integrated with the trimmer.

7. An image forming apparatus, comprising:
the developing device according to claim 1,
wherein the image forming apparatus forms an image on a recording medium that has been supplied.
